(19) United States
(12) Patent Application Publication
(10) Pub. No.: US 2013/0128932 A1
(43) Pub. Date: May 23, 2013

(54) CHANNEL PARAMETER ESTIMATION METHOD

(71) Applicants: Chao-Wang Huang, Taichung City (TW); Hsiang-Tsung Kung, Taipei City (TW); Pang-An Ting, Taichung City (TW)

(72) Inventors: Chao-Wang Huang, Taichung City (TW); Hsiang-Tsung Kung, Taipei City (TW); Pang-An Ting, Taichung City (TW)

(73) Assignee: INDUSTRIAL TECHNOLOGY RESEARCH INSTITUTE, Hsinchu (TW)

(21) Appl. No.: 13/350,720

(22) Filed: Jan. 13, 2012

(30) Foreign Application Priority Data
Nov. 23, 2011 (TW) 100142916

(51) Int. Cl. H04B 15/00; H04B 7/00; H04B 1/00; H04B 1/38

(52) U.S. Cl. 375/219; 455/73; 455/69; 455/63.1

(57) ABSTRACT

A channel parameter estimation method adapted to a wireless communication system is proposed. The wireless communication system includes a transmitter and a receiver. The proposed method includes following steps. The transmitter transmits a plurality of pilot signals to the receiver by using one of a plurality of preconfigured sparse random pilot patterns. The receiver receives the pilot signals, performs a channel parameter estimation on the pilot signals by using a compressive sensing algorithm to obtain a multipath channel number, and selects a pilot pattern for a next cycle among the preconfigured sparse random pilot patterns according to the multipath channel number and a current pilot number. Additionally, the receiver transmits feedback information associated with the selected pilot pattern to the transmitter.

### CROSS-REFERENCE TO RELATED APPLICATION

This application claims the priority benefit of Taiwan application serial no. 100142916, filed on Nov. 23, 2011. The entirety of the above-mentioned patent application is hereby incorporated by reference herein and made a part of this specification.

### BACKGROUND

1. Technical Field

The disclosure relates to a channel parameter estimation method based on sparse random pilot signals of compressive sensing techniques.

2. Related Art

Nowadays, mobile data traffic grows exponentially. Super WiFi is one of the mobile data transmission techniques which receive much attention. The communication standards organization, which drives the adoption of super WiFi, expects to increase the transmission power of WiFi to 1000 milliwatt (mW) and establish 2 kilometers (km) outdoor wireless data links by adopting the super WiFi technology. Since the original indoor transmission channel has a smaller delay spread and is a frequency flat channel, only a small number of pilot signals is required for performing channel parameter estimation. If the WiFi technology is applied outdoors, the outdoor transmission channel has a larger delay spread and is a frequency selective channel. Accordingly, the density of pilot signals should be greatly increased. However, an increase in the number of pilot signals will directly result in a reduction of spectrum efficiency.

Another notable mobile data transmission technique, which receives much attention, is to transmit data through an underwater acoustic channel. Since the transmission characteristic of acoustic waves through water is different than that of wireless electromagnetic signals (including microwave signals) through air, the channel characteristic of underwater acoustic transmission is different from that of microwave transmission. The major difference of channel characteristic comes from the difference between the traveling speed of acoustic waves through water (1500 m/s) and the traveling speed of light in vacuum (3×10⁸ m/s). Thus, the underwater acoustic transmission channel has a long delay spread and sparse channel characteristics. For example, in underwater acoustic transmission, when there are two main transmission paths between a transmitter and a receiver and the two transmission paths are only 1.5 meters away, the two main transmission paths may cause a delay of 1 ms, which is 10 times of sampling period in microwave transmission with a bandwidth of 10 kHz. The long delay spread and sparse channel characteristics may also cause frequency-selective signal distortion in underwater acoustic transmission. Therefore, the underwater acoustic transmission technology requires pilot signals in higher density.

Additionally, if an existing IEEE 802.1af wireless communication technique (using a bandwidth of 5 MHz) is applied to a transmission channel of 700 MHz (corresponding to the TV white space made available by termination of using 700 MHz for transmitting analog TV signals), the simulated situations of two channels (a DVB-T channel and a ITU VA channel) corresponding to 700 MHz bandwidth are shown in following Table 1, and main IEEE 802.1af specification parameters and the simulated situations of foregoing two channels by adopting these specification parameters are shown in following Table 2.

TABLE 1

| | DVB-T Channel | | ITU VA Channel | |
|---|---|---|---|---|
| RMS Delay | 1.2459 | μs | 0.3704 | μs |
| Coherence Bandwidth | 160.53 | kHz | 539.96 | kHz |
| Coherence Time | 10.88 | ms | 10.88 | ms |
| Rate: 60 km/hr | | | | |
| Coherence Time | 5.44 | ms | 5.44 | ms |
| Rate: 120 km/hr | | | | |

The RMS delays and corresponding coherence bandwidths of the DVB-T channel and the ITU VA channel could be obtained from foregoing Table 1, and accordingly the coherence time thereof with the traveling speeds of 60 km/hr and 120 km/hr could be calculated.

TABLE 2

| | |
|---|---|
| Specification Parameters | IEEE 802.11af |
| | (5 MHz) |
| Symbol Length | 12.8 μs |
| CP Length | Data symbol: 3.2 μs |
| (1/4) | CE symbol: 6.4 μs |
| Subcarrier Spacing | 78.125 kHz |
| Pilot Distance | Data symbol: 78.125 kHz |
| | CE symbol: 1.094 MHz (equivalent to |
| | the insertion of 1 pilot signal into |
| | every 14 subcarrier) |
| Coherence Bandwidth | No |
| Pilot Distance <540 kHz ? | |
| Coherence Time | Yes |
| Symbol Duration <10.88 ms ? | |
| (Rate: 60 km/hr) | |

The symbol length, CP length, subcarrier spacing, pilot distance of wireless communication techniques compliant with the IEEE 802.11af specifications and the coherence bandwidths and coherence time thereof in the application of 700 MHz bandwidth are first listed in foregoing Table 2. As shown in Table 2, the coherence time of the wireless communication technique compliant with the IEEE 802.11af specifications in foregoing two channels is long enough, and the channel has a slow changing rate in the time domain. However, the pilot distance thereof is over 1 MHz, while the coherence bandwidth thereof in foregoing two channels is only about 540 kHz or 160 kHz. Thus, no channel parameter estimation procedure could be effectively performed without changing the original IEEE 802.11af pilot signal design.

Below, another UWA OFDM transmission technique will be simulated and compared. The main system operation parameters of this UWA OFDM transmission technique are listed in following Table 3.

TABLE 3

| System Operation Parameter | UWA OFDM | |
|---|---|---|
| Bandwidth | 9.8 | kHz |
| Center Frequency | 13 | kHz |
| Total Subcarriers | 1024 | |
| Subcarrier Spacing | 9.5 | Hz |
| OFDM Symbol Duration | 105 | ms |
| Guard Interval | 25 | ms |
| Transmitter Power | Tens of Watts) | |
| Consumption | | |
| Receiver Power Consumption | 100 | mW to several Watts |
| Delay Spread | 20 | ms |
| RMS Delay | 5 | ms |
| Coherence Bandwidth | 40 | Hz |
| Mobile Speed | 5 | m/s |
| Coherence Time | 9.76 | ms |
| Conventional Pilot Distance | 9.5 * 2 = 19 | Hz |

The bandwidth, CP length, center frequency, total subcarriers, subcarrier spacing, OFDM symbol duration, guard interval, transmitter power consumption, receiver power consumption, delay spread, RMS delay, coherence bandwidth, mobile speed, coherence time, and conventional pilot distance of UWA OFDM transmission technique are first listed in Table 3. Referring to Table 3, since acoustic waves consume a lot of power while transmission signal traveling underwater, the transmitter power consumption thereof is much greater than the receiver power consumption thereof. Moreover, in order to avoid inter-symbol interference (ISI), the guard interval is designed to be 25 ms. After adding the guard interval to the OFDM symbol duration, the entire OFDM symbol takes up 130 ms, which is greater than the coherence time of the underwater transmission channel. Thus, the UWA OFDM transmission technique experiences time-varying channels. Additionally, if the conventional pilot signal design is adopted, at least two pilot signals are needed to be inserted into the coherence bandwidth according to the sampling theory. Accordingly, two in every four subcarriers are needed to be inserted with pilot signals. As a result, the spectrum efficiency may decrease and the transmitter power consumption may increase, which is not good to battery powered underwater communication devices.

In pilot signal design, several situations have to be resolved in order to improve the UWA OFDM transmission technique: (1) relatively small coherence bandwidth, the conventional pilot signal design is adopted, and at least two pilot signals are needed to be inserted into the coherence bandwidth according to the sampling theory; (2) relatively small coherence time, iterative receiver may be helpful in channel parameter estimation; (3) relatively high power consumption at the transmitter.

Most existing channel parameter estimation techniques adopt rectangular pilot and scattered pilot designs based on the sampling theory. Accordingly, at least two pilot subcarriers are needed to be inserted within the coherence bandwidth of a channel in order to carry out correct channel parameter estimation, and the pilot number is fixed, which cause reduction on the spectrum efficiency.

Additionally, if a pilot subcarrier is FFT pruned in the pilot signal design adopted by an existing channel parameter estimation technique, the channel parameter estimation may not be carried out correctly. Moreover, since the pilot signal design of an existing technique cannot be adaptively adjusted according to the multipath number of a channel, the channel estimation performance and spectrum efficiency cannot be optimized. Furthermore, when a large number of multipath channels are encountered in channel parameter estimation process, an existing channel parameter estimation technique may not be able to carry out the channel parameter estimation correctly.

Thereby, how to reduce the number of pilot signals for time-varying channel or frequency selective channel, and reduce unnecessary transmission power without sacrificing the performance of channel parameter estimation is a major subject in the industry.

### SUMMARY

A channel parameter estimation method is introduced herein.

According to an exemplary embodiment of the disclosure, a channel parameter estimation method is provided. The channel parameter estimation method is adapted to a wireless communication system. The wireless communication system includes a transmitter and a receiver. The channel parameter estimation method includes following steps. The transmitter transmits a plurality of pilot signals to the receiver by using one of a plurality of preconfigured sparse random pilot patterns. The receiver receives the plurality of pilot signals, performs a channel parameter estimation on the plurality of pilot signals by using a compressive sensing algorithm to obtain a multipath channel number, selects a pilot pattern for a next cycle among the preconfigured sparse random pilot patterns according to the multipath channel number and a current pilot number, and transmits feedback information associated with the selected pilot pattern to the transmitter.

According to an exemplary embodiment of the disclosure, a channel parameter estimation method is provided. The channel parameter estimation method is adapted to a receiver and includes following steps. A plurality of pilot signals allocated in a sparse random pilot pattern is received at the receiver. A channel parameter estimation is performed on the pilot signals at the receiver by using a compressive sensing algorithm to obtain a multipath channel number. A channel response in the delay-doppler domain is obtained at the receiver according to the multipath channel number and the plurality of pilot signals.

According to an exemplary embodiment of the disclosure, a channel parameter estimation method is provided. The channel parameter estimation method is adapted to a transmitter and includes following steps. A plurality of pilot signals is transmitted at the transmitter to a receiver by using one of a plurality of preconfigured sparse random pilot patterns. Feedback information associated with a pilot pattern selected by the receiver is received by the transmitter. Additionally, a plurality of pilot subcarriers corresponding to a pilot pattern indicated by the feedback information is obtained at the transmitter according to the feedback information, and during a next cycle, the plurality of pilot signals are inserted at the transmitter into the pilot subcarriers and transmitted to the receiver.

According to an exemplary embodiment of the disclosure, a channel parameter estimation method is provided. The channel parameter estimation method is adapted to a receiver and includes following steps. A plurality of pilot signals allocated in a sparse random pilot pattern from a transmitter is received by the receiver. A channel parameter estimation is performed on the plurality of pilot signals at the receiver by using a compressive sensing algorithm to obtain a multipath channel number. A pilot pattern is selected at the receiver for a next cycle among a plurality of preconfigured sparse random pilot patterns according to the multipath channel number and a current pilot number. Additionally, feedback information associated with the selected pilot pattern is transmitted at the receiver to the transmitter.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a sparse random pilot pattern according to an exemplary embodiment of the disclosure.

FIG. 2 illustrates time domain channel response of a channel.

FIG. 3 illustrates frequency domain channel response of a channel.

FIG. 4 illustrates Delay-Doppler domain channel response of a channel.

FIG. 5 is a functional block diagram of a transmitter according to an exemplary embodiment of the disclosure.

FIG. 6 is a functional block diagram of a receiver according to an exemplary embodiment of the disclosure.

FIG. 7 is a functional block diagram of a compressive sensing channel parameter estimator according to an exemplary embodiment of the disclosure.

FIG. 8 is a flowchart of a compressive sensing channel parameter estimation method according to an exemplary embodiment of the disclosure.

FIG. 9 is a flowchart of an adaptive pilot pattern selection method according to an exemplary embodiment of the disclosure.

FIG. 10 illustrates a mean squared error (MSE) simulation result of OFDM channel estimation based on compressive sensing technique.

FIG. 11 is a flowchart of a channel parameter estimation method according to an exemplary embodiment of the disclosure.

FIG. 12 is a flowchart of a channel parameter estimation method according to an exemplary embodiment of the disclosure.

FIG. 13 is a flowchart of a channel parameter estimation method according to an exemplary embodiment of the disclosure.

FIG. 14 is a flowchart of a channel parameter estimation method according to an exemplary embodiment of the disclosure.

### DETAILED DESCRIPTION OF DISCLOSED EMBODIMENTS

Reference will now be made in detail to exemplary embodiments of the disclosure, examples of which are illustrated in the accompanying drawings, wherein like reference numerals refer to the like elements throughout. The exemplary embodiments are described below in order to explain the disclosure by referring to the figures.

The disclosure provides a channel parameter estimation method based on compressive sensing sparse random pilot signals, an adaptive pilot pattern selection method, and a wireless communication system (including at least one transmitter and at least one receiver) using the same. The channel parameter estimation method could adaptively assign pilot patterns (i.e., could adaptively change pilot pattern (including pilot number) based on the characteristics of a time-varying channel). In addition, the channel parameter estimation method could be tolerant to FFT pruning of OFDM, achieve spectrum interference management, and be adapted to time-varying channel characteristics, and so forth. For example, FFT pruning may take place at the band of 700 MHz, and with this frequency band, an analog TV uses the frequency of 6 MHz while a wireless microphone device uses the frequency of merely 200 kHz. Thus, the subcarriers corresponding to the frequency of 200 kHz used by the wireless microphone device are needed to be adaptively pruned (i.e., these subcarriers are not used for transmitting pilot signals) to prevent interference from the wireless microphone device. Alternatively and equivalently, spectrum interference management is performed to reduce interference to the wireless microphone device.

Following Table 4 shows the comparison of pilot patterns between the channel parameter estimation method provided by the disclosure and two existing wireless communication techniques. The two wireless communication techniques in Table 4 are respectively a wireless communication technique compliant with the DVB-T (2k mode) specification and a wireless communication technique compliant with the IEEE 802.11g specification. Table 4 lists the differences respectively between foregoing two wireless communication techniques and the uniformly at random pilot pattern provided by the disclosure in following aspects: pilot pattern, pilot signal density (frequency domain), pilot signal density (time domain), channel estimation method, occupied system resources, and FFT Pruning tolerance, and so forth. Herein, it is noted that the parameters in Table 4 corresponding to IEEE 802.11g are obtained from an indoor simulation, and the pilot signal density is needed to be increased to 25% when the simulation is performed outdoors. Compared to IEEE 802.11g, the sparse random pilot pattern requires an outdoor pilot signal density of 9.37% (i.e., only occupies 9.37% system resources). Thus, the spectrum efficiency is greatly improved by using the uniformly at random pilot pattern provided by the disclosure. Further, the channel estimation is based on compressive sensing thereof has improved performance and increased tolerance to FFT pruning.

TABLE 4

| | Sparse Random | | |
|---|---|---|---|
| | Pilot Pattern | | |
| | Provided By | DVB-T | WiFi |
| | The Disclosure | (2k mode) | IEEE 802.11g |
| Pilot | Random with | Scattered pilot | Rectangular pilot |
| Pattern | uniform | pattern | pattern |
| | distribution | | |
| Pilot Signal | K = 4 | K = 12 | K = 14 |
| Density | 78.125 kHz × 4 = | 4.464 kHz × 12 = | 78.125 kHz × 14 = |
| (Frequency | 312.5 kHz < | 53.57 kHz < | 1093.75 kHz < |
| Domain) | coherence | coherence | coherence |
| | bandwidth | bandwidth | bandwidth |
| Pilot Signal | ΔL = 1 (12.8 μs) | L = 1 (280 μs) | ΔL = 1 (12.8 μs) |
| Density | | ¼CP | |
| (Time | | | |
| Domain) | | | |
| Channel | compressive | 2-D MMSE | 1-D MMSE |
| Estimation | sensing (good | (moderate | (bad performance) |
| Method | performance) | performance) | |
| System | 9.37% | 8.33% | 6.25% |
| resources | (25% if IEEE | | (indoor) |
| taken | 802.11g is | | |
| | adopted) | | |
| FFT | High | Moderate | Low |
| Pruning | | | |
| Tolerance | | | |

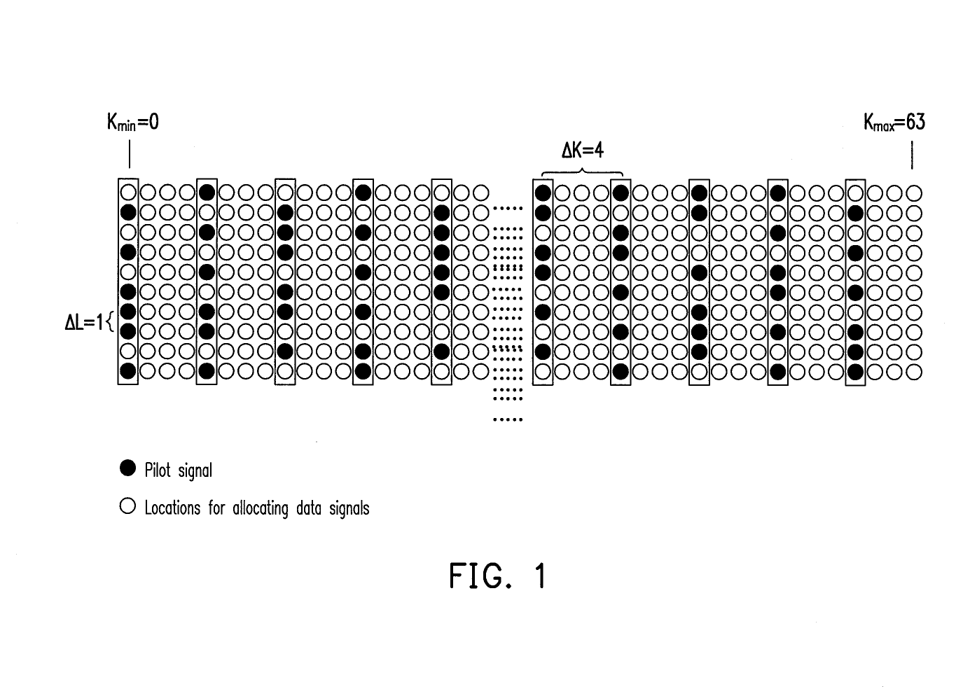

FIG. 1 illustrates a sparse random pilot pattern according to an exemplary embodiment of the disclosure. Referring to FIG. 1, the sparse random pilot pattern is merely an example adopted for explaining that the sparse random pilot pattern has a sparse random/uniformly at random structure in an OFDM symbol instead of the rectangular or scattered layout presented by the pilot pattern in a conventional technique. A rectangular pilot pattern or a scattered pilot pattern cannot be used for performing compressive sensing-based channel estimation, or the compressive sensing-based channel estimation cannot generate a satisfying result with the rectangular pilot pattern or the scattered pilot pattern.

Referring to FIG. 1, the sparse random pilot pattern has 63 subcarriers (with frequency domain indexes from Kₘᵢₙ=0 to Kₘₐₓ=63), black spots indicate locations for allocating pilot signals, and white spots indicate locations for allocating data signals. In the frequency domain (as indicated by the ordinate), each subcarrier could be assigned with 6 pilot signals, and a shortest distance between adjacent subcarriers assigned with pilot signals is ΔK=4 (i.e., the pilot signal density in the frequency domain is ΔK=4). In the time domain (on the horizontal axis), each time slot could be assigned with at most 6 pilot signals, and a shortest distance between adjacent time slots assigned with pilot signals is ΔL=1 (i.e., the pilot signal density in the time domain is ΔL=1). The sparse random pilot pattern in the disclosure is not limited to that illustrated in FIG. 1, and any OFDM symbol presenting a sparse random structure could be applied to the channel parameter estimation method or an adaptive pilot pattern selection method in the disclosure.

Based on the wireless communication theory, the longer the delay spread is, the greater the channel varies in the frequency domain. Accordingly, the effect produced by channel frequency selectivity needs to be taken into consideration. If a conventional sampling theory is adopted, since the greater the channel changes in the frequency domain, the more pilot signals are required for estimating channel parameters, the spectrum efficiency will be reduced. Assuming that the root-mean-squared (RMS) delay a, of a channel is 0.3704 μs (corresponding to an ITU VA channel), the coherence bandwidth B_{c} of the channel is as shown by following equation (1):

$${B}_{c} \approx \frac{1}{5 {σ}_{τ}} = 1 / 5 * 0.3704 µ s = 539.96 kHz \qquad ( 1 )$$

The traveling speed ν of the coherence time of foregoing ITU VA channel in a wireless communication device is 60 km/hr, and which could be expressed as following equation (2) when the center frequency fc of microwave carrier is 700 MHz (by assuming that the traveling speed c of microwave carrier is speed of light):

$$\sqrt{\frac{9}{16 π {f}_{m}^{2}}} = \frac{0.423}{{f}_{m}} = \frac{0.423 c}{v {f}_{c}} = 10.88 ms \qquad ( 2 )$$

It can be understood based on foregoing equations (1) and (2) that, since the channel changes slower in the time domain, the frequency selectivity of a channel is far more important than the time selectivity thereof when a WiFi system is moved to an outdoor mobile channel, and, the time selectivity thereof could be ignored.

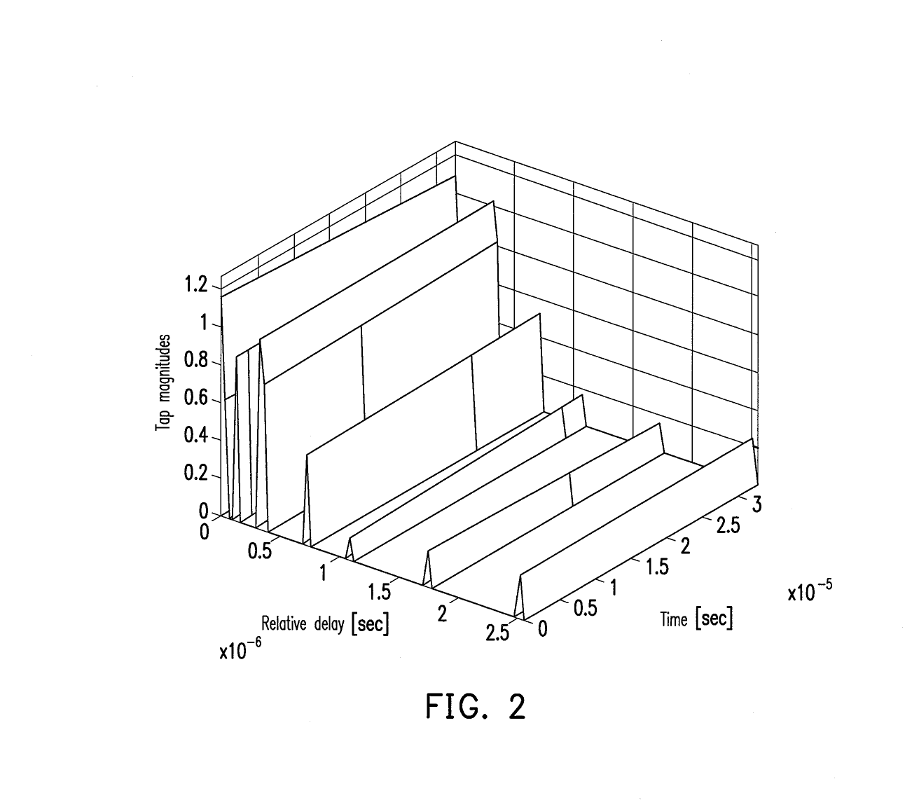

FIG. 2 illustrates time domain channel response of a channel. The channel illustrated in FIG. 2 could correspond to the situation that the traveling speed ν of an ITU VA channel is 60 km/hr in a wireless communication device and the center frequency fc of microwave carrier is 700 MHz. It could be understood by referring to FIG. 2 that the channel changes slowly in the time domain, only a few paths thereof have tap magnitudes, and the tap magnitudes of the paths attenuate from the main path to other paths. Additionally, the response of the overall delay domain presents a sparse situation (i.e., only a few paths have response values while the response values of other paths are all 0).

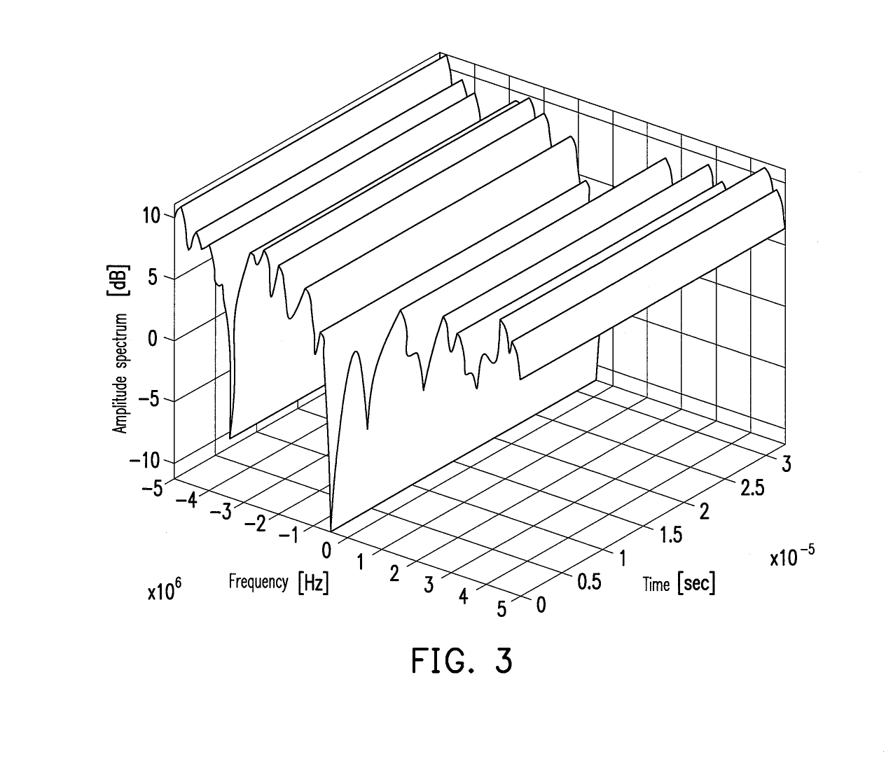

FIG. 3 illustrates frequency domain channel response of a channel. The frequency domain response of the channel illustrated in FIG. 3 corresponds to the time domain response illustrated in FIG. 2. When the time domain response illustrated in FIG. 2 is transformed to the frequency domain, the response of the channel in the frequency domain does not present a sparse situation but presents a lot of changes. If a channel parameter estimation is performed in the frequency domain, a lot of system resources will be occupied, and accordingly the spectrum efficiency will be reduced. Thus, the pilot pattern of an effective channel parameter estimation should not be designed in the frequency domain. Even though the time domain response is sparser than the frequency domain response, it is not sparse enough to improve the overall spectrum efficiency as expected.

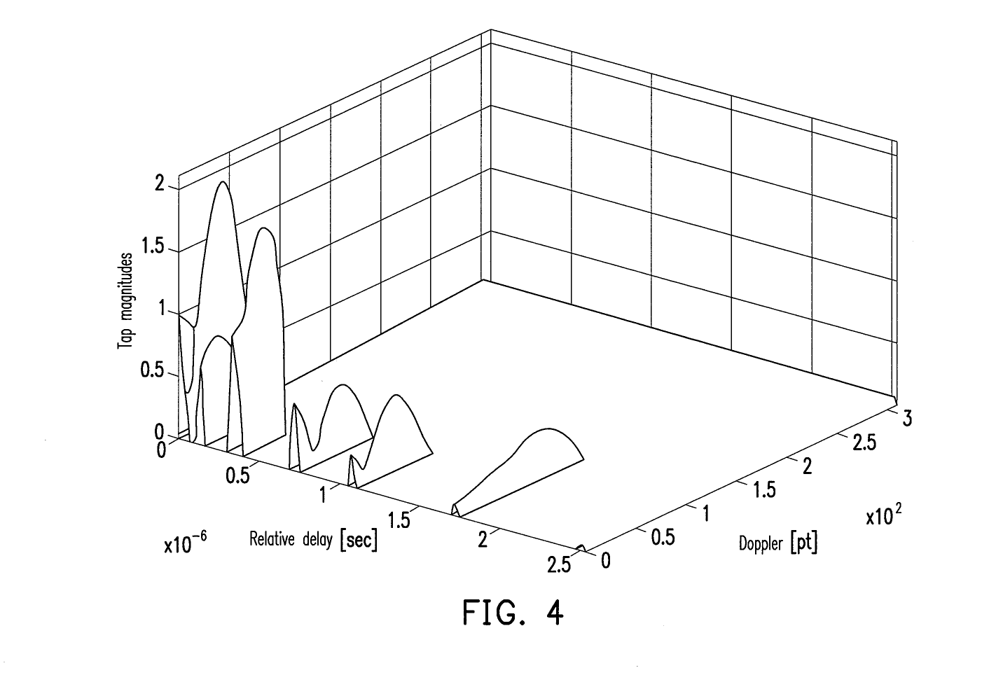

FIG. 4 illustrates Delay-Doppler domain channel response of a channel. When the time domain response illustrated in FIG. 2 is transformed into the Delay-Doppler domain (i.e., each path is FFT transformed), the channel response in the Delay-Doppler domain has tap magnitudes clearly around DC (corresponding to relative delay 0) and presents a sparser situation than the time domain response. Thus, the receiver could estimate the channel response in the Delay-Doppler domain and then transforms the channel response estimated in the Delay-Doppler domain into a time-frequency domain channel response through a two-dimensional (2D) FFT. Thereby, the system resource occupied by pilot signals is greatly reduced without sacrificing the performance of the channel parameter estimation.

It is assumed that the frequency domain channel response illustrated in FIG. 3 is H(n,k) (wherein n is a time index, and k is a subcarrier index), the time domain channel response illustrated in FIG. 2 is then IFFT(H(n,k)) (i.e., the frequency domain channel response is transformed into a time domain function through FFT). The Delay-Doppler domain channel response illustrated in FIG. 4 could be expressed in following equation (3):

$$\tilde{F} [ m , i ] ≡ {\sum }_{q = 0}^{N - 1} F [ m , i + qL ] \qquad ( 3 )$$

In foregoing equation (3), m is a delay index, i is a time index, l is an OFDM symbol index, N is the total number of samples received within an OFDM symbol time (received total samples), and L is packet length. The Delay-Doppler domain channel response expressed in foregoing equation (3) is transformed through 2D FFT to obtain the time-frequency domain channel response expressed by following equation (4):

$${H}_{l , k} = {\sum }_{m = 0}^{K - 1} {\sum }_{i = 0}^{L - 1} \tilde{F} [ m , i ] {e}^{- j 2 π ( \frac{km}{K} - \frac{li}{{N}_{r}} )} \qquad ( 4 )$$

In foregoing equation (4), m is a delay index, i is a time index, l is an OFDM symbol index, k is a subcarrier index, K is a total subcarriers, L is a total time slots, and Nᵣ is the total number of samples received within an OFDM symbol time (received total samples). \tilde{F}[] in foregoing equation (4) represents the Delay-Doppler domain channel response. The left side of the equation (4) is the time-frequency domain channel response.

On the other hand, when a wireless communication device at the receiver end is about to perform channel parameter estimation, time-frequency domain channel response could be gradually established according to the relationship between the time-frequency domain channel response and the Delay-Doppler domain channel response, as indicated by following equation (5):

$${H}_{{l}^{′} Δ L , {k}^{′} Δ K} = {( - 1 )}^{{l}^{′}} {\sum }_{m = 0}^{D - 1} {\sum }_{i = 0}^{I - 1} {F}^{′} [ m , i - \frac{I}{2} ] {e}^{- j 2 π ( \frac{{k}^{′} m}{D} - \frac{{l}^{′} i}{I} )} \qquad ( 5 )$$

In foregoing equation (5), m is a delay index, i is a time index, l′ is a pilot signal OFDM symbol index, k′ is a pilot subcarrier index, D is a total number of pilot subcarriers, I is the total number of pilot signal time slots (total time slots), Nᵣ is the total number of samples received within an OFDM symbol time (received total samples), ΔL is the pilot signal density in the time domain, and ΔK is the pilot signal density in the frequency domain. F′[] in foregoing equation (5) represents the delay-doppler domain channel response. The vector H at the left side of the equation (5) is the time-frequency domain channel response, and the equation (5) could be further revised into following matrix expression (6):

v=Φ·u+w (6)

In foregoing matrix expression (6), the vector v is an m×1 vector, and the elements thereof are the coefficients of the time-frequency domain channel response. The matrix Φ is an m×N matrix, which represents a measurement matrix. The vector u is an N×1 vector, which is a vector established by connecting each row of the original 2D matrix representing the Delay-Doppler domain channel response. The vector u is a sparse matrix, which represents the Delay-Doppler domain channel response, while most elements of the vector u have the value 0, and those elements having other values than 0 represent the coefficients of the response of multipath channels in the delay-doppler domain. The vector w is an m×1 vector, and the elements thereof are white noises.

In the present disclosure, channel parameters could be estimated through compressive sensing, and the measurement matrix Φ could be established according to these channel parameters. Additionally, the measurement matrix Φ is a sparse orthogonal matrix (for example, a Gaussian random matrix or a random binomial matrix) or a matrix formed through orthogonal matrix row random selection.

Below, the matrix expression (6) is transformed into the following matrix expression (7):

$${[ \begin{matrix}{H}_{0} \\ {H}_{1} \\ ⋮ \\ ⋮ \\ {H}_{m - 2} \\ {H}_{m - 1}\end{matrix} ]}_{m \times 1} = {A}_{m \times N} \cdot {B}_{N \times N} \cdot {[ \begin{matrix}{f}_{0}^{′} \\ 0 \\ {f}_{1}^{′} \\ 0 \\ ⋮ \\ 0 \\ {f}_{2}^{′} \\ 0 \\ ⋮ \\ 0\end{matrix} ]}_{N \times 1} + {[ \begin{matrix}{W}_{0} \\ {W}_{1} \\ ⋮ \\ ⋮ \\ {W}_{m - 2} \\ {W}_{m - 1}\end{matrix} ]}_{m \times 1} \qquad ( 7 )$$

In foregoing matrix expression (7), the product of the matrix A and the matrix B is the measurement matrix Φ. The elements having non-zero values in the measurement matrix Φ represent the positions for allocating pilot signals in an OFDM symbol. In the present disclosure, a 2D FFT matrix is served as the matrix B, where the 2D FFT matrix is an orthogonal matrix. The matrix A is a selection matrix, which is used for selecting specific rows in the 2D FFT matrix to carry out compressive sensing process. On the other hand, the matrix A is formed by randomly selecting m rows in the orthogonal matrix B. In the matrix expression (7), m represents a pilot number. In addition, it should be noted that both the transmitter and the receiver could acquire the 2D FFT matrix and the matrix A before the communication starts. A communication device at the receiver end obtains Q non-zero coefficients in the vector u through compressive sensing technique, and actually the Delay-Doppler domain channel response may have R coefficients, where Q<=R. In addition, by estimating channel parameters through compressive sensing technique, the S channel parameters obtained each time are corresponding to S multipath channels having greatest impact, where S<=Q. Thus, the coefficients of the channel response obtained during a previous estimation of channel parameters could be removed from the vector u so that the remaining coefficients (corresponding to the multipath channels which were not found during the previous channel parameter estimation) of the channel response could be obtained during another channel parameter estimation operation.

While re-establishing the time-frequency domain channel response, all the coefficients of the Delay-Doppler domain channel response obtained during one or more channel parameter estimation operations are filled into the vector u into matrix expression (7), and a vector v representing the time-frequency domain channel response is obtained by using the product of the measurement matrix Φ and the vector u.

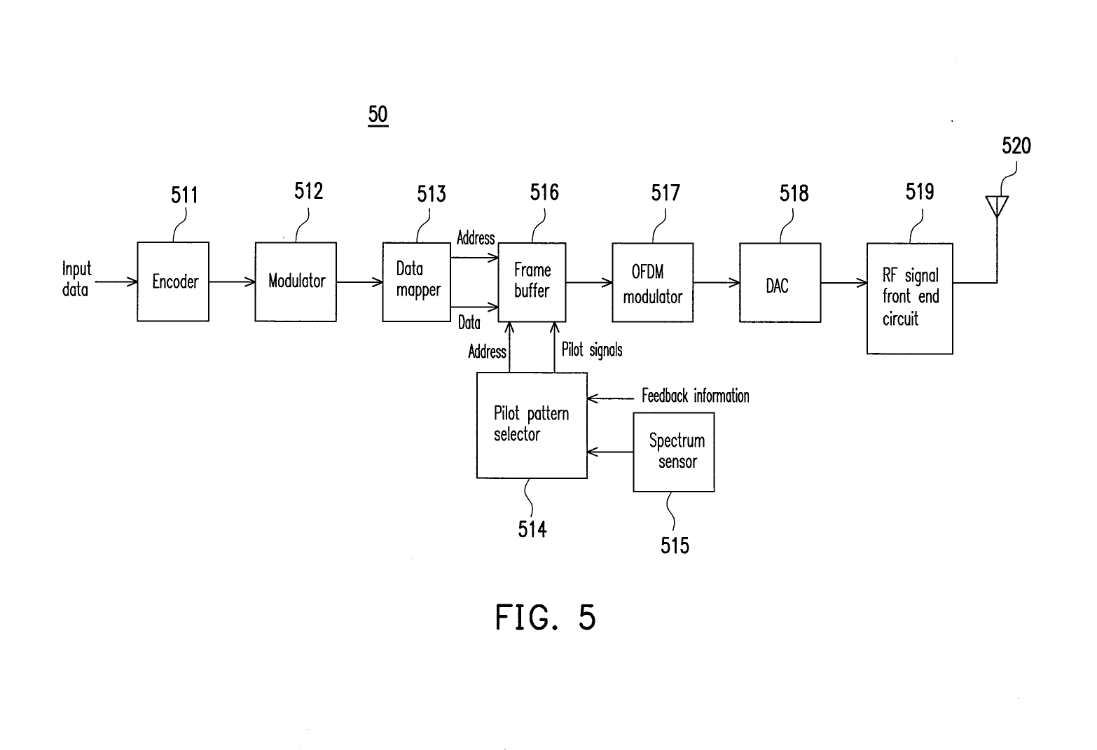

FIG. 5 is a functional block diagram of a transmitter according to an exemplary embodiment of the disclosure. In a practical implementation, the transmitter illustrated in FIG. 5 may be a base station. The transmitter 50 includes an encoder 511, a modulator 512, a data mapper 513, a pilot pattern selector 514, a spectrum sensor 515, a frame buffer 516, an OFDM modulator 517, a digital-to-analog converter (DAC) 518, an RF front end circuit 519, and an antenna 520.

Referring to FIG. 5, the encoder 511 receives input data and encodes the input data into encoded data. The modulator 512 is connected to the encoder 511. The modulator 512 receives the encoded data and modulates the encoded data into modulated data. The data mapper 513 is connected to the modulator 512. The data mapper 513 receives the modulated data and provides addresses for allocating data into OFDM subcarriers and the modulated data to the frame buffer 516. To be illustrated more clearly, the data mapper 513 needs to know which OFDM subcarriers need to be assigned with pilot signals first. Thus, in a practical application, the modulator 512 is connected to the pilot pattern selector 514, the pilot pattern selector 514 provides the addresses of the OFDM subcarriers for assigning pilot signals to the data mapper 513, and the data mapper 513 provides the addresses of other OFDM subcarriers to the frame buffer 516.

The pilot pattern selector 514 further obtains feedback information from a wireless communication device at the receiver end. The feedback information includes a pilot pattern index transmitted by the wireless communication device back to the transmitter. The pilot pattern index is selected by the receiver. The pilot pattern selector 514 uses a pilot pattern corresponding to the pilot pattern index. However, the feedback information is not only used for transmitting the pilot pattern index back to the transmitter. In other embodiments, the feedback information could also be used for transmitting other important information, such as the multipath number and channel quality information actually detected by the receiver.

The spectrum sensor 515 is not a necessary component device of the transmitter 50, which provides spectrum sensing result to the pilot pattern selector 514. However, in other embodiments, the pilot pattern selector 514 may also obtain the spectrum sensing result from a sensor outside the transmitter 50. The spectrum sensing result could be used for determining the OFDM subcarrier to be FFT pruned such that those frequencies currently used by other wireless communication devices are not affected or are avoided. When the pilot pattern selector 514 detects that the frequency of any OFDM subcarrier in the pilot pattern corresponding to the pilot pattern index is used by other wireless communication devices, the pilot pattern selector 514 backs off and uses an OFDM subcarrier adjacent to a FFT pruned OFDM subcarrier instead. The operation of the transmitter 50 is made very flexible by the FFT pruning operation.

The frame buffer 516 receives addresses of OFDM subcarriers to be allocated with pilot signals and the pilot signals from the pilot pattern selector 514. The OFDM modulator 517 is connected to the frame buffer 516. The OFDM modulator 517 receives the addresses of the OFDM subcarriers, the pilot signals, and modulated data, allocates the pilot signals and the modulated data to the corresponding OFDM subcarriers according to the addresses of the OFDM subcarriers, so as to generate an OFDM symbol. The DAC 518 is connected to the OFDM modulator 517. The DAC 518 receives the OFDM symbol and transforms the OFDM symbol into an analog signal. The RF front end circuit 519 then performs various operations (for example, frequency conversion, gain processing, or filtering) on the analog signal. The antenna 520 transmits the RF signal carrying the OFDM symbol.

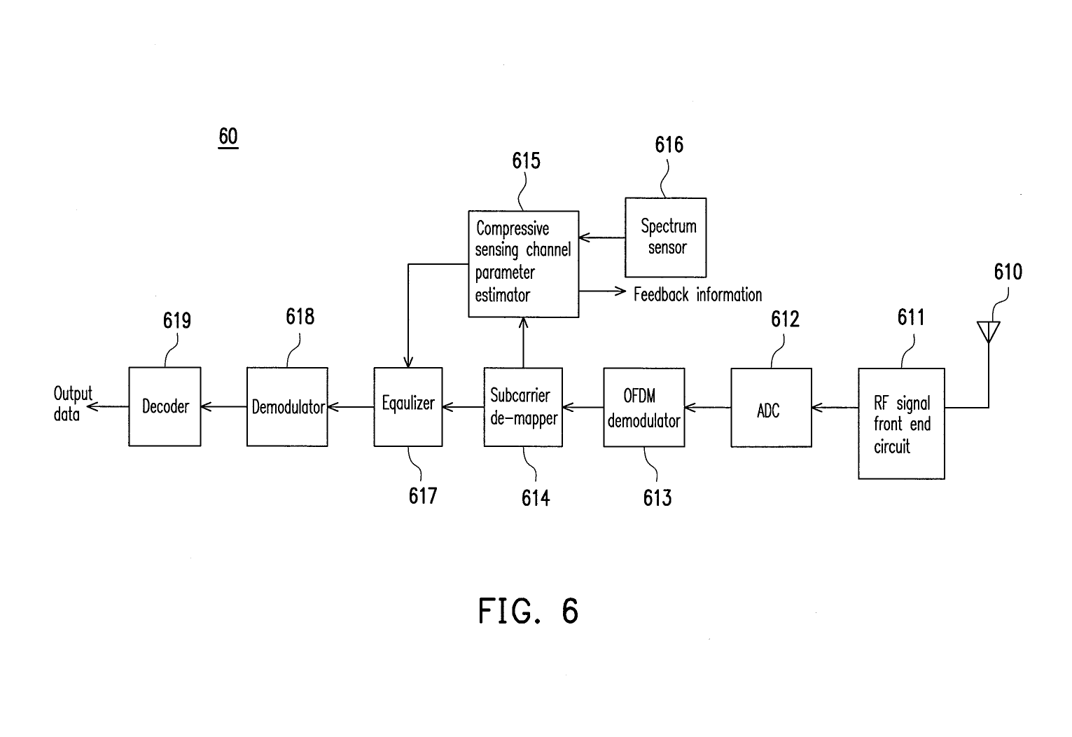

FIG. 6 is a functional block diagram of a receiver according to an exemplary embodiment of the disclosure. In a practical implementation, the receiver illustrated in FIG. 6 may be a wireless communication device or a mobile station. The receiver 60 includes an antenna 610, a radio frequency (RF) signal front-end circuit 611, an analog-to-digital converter (ADC) 612, an OFDM demodulator 613, a subcarrier de-mapper 614, a compressive sensing channel parameter estimator 615, a spectrum sensor 616, an eqaulizer 617, a demodulator 618, and a decoder 619.

Referring to FIG. 6, the antenna 610 receives an RF signal carrying OFDM symbols. The RF front end circuit 611 is connected to the antenna 610. The RF front end circuit 611 receives the RF signal carrying OFDM symbols from the antenna 610 and performs frequency conversion, gain processing, or filtering on the RF signal to generate an analog signal with OFDM symbols. The ADC 612 is connected to the RF front end circuit 611. The ADC 612 converts the analog signal with OFDM symbols into a digital signal. The OFDM demodulator 613 is connected to the ADC 612. The OFDM demodulator 613 captures the OFDM symbols from the digital signal and provides the OFDM symbols to the subcarrier de-mapper 614. The subcarrier de-mapper 614 provides pilot subcarriers in the OFDM symbol to the compressive sensing channel parameter estimator 615 and provides data subcarriers in the OFDM symbols to the eqaulizer 617.

After performing the corresponding compressive sensing channel parameter estimation process by using the pilot subcarriers, the compressive sensing channel parameter estimator 615 obtains the pilot signals, a multipath number, and a current time-frequency domain channel response and provides feedback information to the transmitter. The feedback information contains pilot pattern indexes to be transmitted back to the transmitter by the wireless communication device. The transmitter could use the pilot pattern corresponding to the pilot pattern index. However, the feedback information is not only used for transmitting the pilot pattern index back to the transmitter. In other embodiments, the feedback information could also be used for transmitting other important information, such as the multipath number and channel quality information actually detected by the receiver.

The spectrum sensor 616 is not a necessary component of the receiver 60, which provides a spectrum sensing result to the compressive sensing channel parameter estimator 615. However, in other embodiments, the compressive sensing channel parameter estimator 615 may also obtain the spectrum sensing result from a sensor outside the receiver 60. The compressive sensing channel parameter estimator 615 could determine FFT pruned OFDM subcarriers according to the spectrum sensing result and could obtain correct pilot signals accordingly.

The compressive sensing channel parameter estimator 615 provides a current time-frequency domain channel response to the eqaulizer 617. The eqaulizer 617 compensates for the interference of the wireless transmission channel to data subcarriers and generates corresponding modulated data. Subsequently, the demodulator 618 demodulates the modulated data to obtain encoded data. The decoder 619 then decodes the encoded data and generates output data. The output data is corresponding to the input data at the transmitter end.

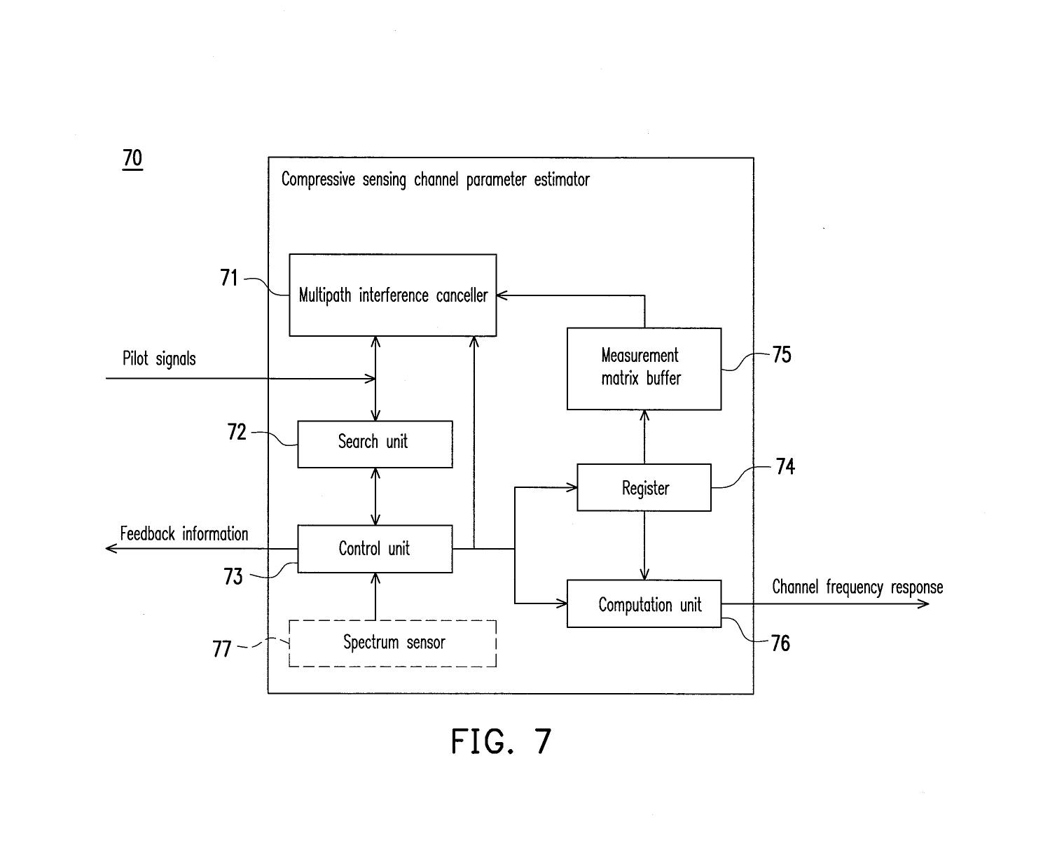

FIG. 7 is a functional block diagram of a compressive sensing channel parameter estimator according to an exemplary embodiment of the disclosure. The compressive sensing channel parameter estimator 70 could be applied to the compressive sensing channel parameter estimator 615 in the embodiment illustrated in FIG. 6. However, the disclosure is not limited thereto. Referring to FIG. 7, the compressive sensing channel parameter estimator 70 includes a multipath interference canceller 71, a search unit 72, a control unit 73, a register 74, a measurement matrix buffer 75, an operation unit 76, and a spectrum sensor 77. The spectrum sensor 77 is not a necessary component of the compressive sensing channel parameter estimator 70. The compressive sensing channel parameter estimator 70 may also obtain the spectrum sensing result from an external sensor.

The multipath interference canceller 71 receives pilot subcarriers and selectively cancels the interference generated by obtained multipath channels impacting on the pilot subcarriers during the second compressive sensing operation, so that the search unit 72 could search for remaining multipath channels during the second compressive sensing operation. The multipath interference canceller 71 obtains the multipath channels (including the positions of the multipath channels in the vector u in foregoing matrix expression (7) and the coefficients of the Delay-Doppler domain channel response thereof) from the search unit 72.

However, not every OFDM symbol is needed to be performed with two compressive sensing operations. When the number T of multipath channels is smaller than the pilot number Q, only one compressive sensing operation could be performed to obtain T multipath channels with the highest response values.

The search unit 72 searches for multipath channels (or search paths) in pilot subcarriers by using a compressive sensing algorithm. The performance of the search unit 72 is restricted by the pilot number. When the pilot number in a pilot pattern is Q, one compressive sensing operation could only find Q multipath channels with highest response values. The searching algorithm adopted by the search unit 72 may be the best pursuit algorithm or the orthogonal matching pursuit algorithm. The search unit 72 provides the multipath channels that it finds to the control unit 73 in each iteration.

The control unit 73 is connected to the search unit 72. The control unit 73 receives information about the multipath channels and determines a number of iterations. To determine the number of iterations, the control unit 73 performs a first compressive sensing operation (first iteration) or a second compressive sensing operation (second iteration) on the pilot subcarriers of an OFDM symbol, selects multipath channels according to information of the multipath channels, and stores the multipath channels into the register 74. In addition, when the control unit 73 determines that no more multipath channel to be searched, the control unit 73 re-establishes all the currently stored (or obtained) multipath channels to obtain the vector u in foregoing matrix expression (7). The operation unit 76 receives the vector u and generates a product of the vector u and a 2D FFT matrix (for example, the matrix B in foregoing matrix expression (7)) to obtain the current time-frequency domain channel response.

The control unit 73 further receives a spectrum sensing result from the spectrum sensor 77 or an external sensor, selects one of a plurality of preconfigured (and are known to both the transmitter and the receiver) sparse random pilot patterns according to the multipath channel number, the pilot number, and/or the spectrum sensing result, and transmits a pilot pattern index corresponding to the sparse random pilot pattern to the transmitter.

When the control unit 73 determines that two iterations are to be performed, it firstly stores the multipath channels found by the first iteration into the register 74 and updates the vector u and the measurement matrix Φ in foregoing matrix expression (7) according to these multipath channels. The measurement matrix buffer 75 generates the product of the measurement matrix Φ and the vector u. Subsequently, the multipath interference canceller 71 cancels the interference produced by the multipath channels found by the first iteration on the pilot subcarriers of the same OFDM symbol so that the second iteration could be performed to search for remaining multipath channel.

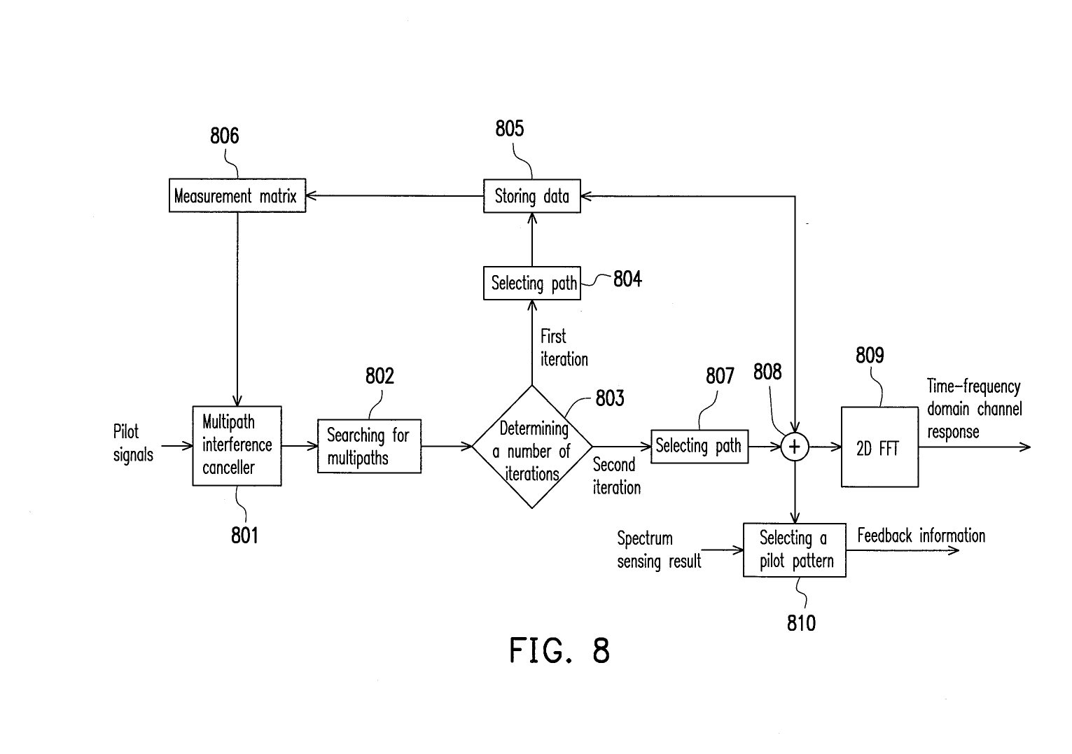

FIG. 8 is a flowchart of a compressive sensing channel parameter estimation method according to an exemplary embodiment of the disclosure. The compressive sensing channel parameter estimation method is adapted to the receiver 60 and the compressive sensing channel parameter estimator 70. Below, the compressive sensing channel parameter estimation method will be explained by using an assumptive channel parameter estimation process. Herein it is assumed that the pilot number Q is 6 and the actual multipath channel number R is 8.

Referring to both FIG. 7 and FIG. 8, while performing the first iteration, because there is no data in the register 74 (i.e., no multipath channel is found), step 801 is skipped and step 802 is directly executed. In step 802, the search unit 72 searches for multipath channels (herein 6 multipath channels are found). In step 803, the control unit 73 determines the current number of iterations. When the current number of iterations is the first iteration, step 804 is executed after step 803. When the current number of iterations is the second iteration, step 807 is executed after step 803.

In step 804, the control unit 73 selects a path (path selection) according to the multipath channels found by the search unit 72. In step 805, the control unit 73 updates the 6 multipath channels into the vector u in the matrix expression (7) and stores data (information about the vector u and the 6 multipath channels) into the register 74. In step 806, the control unit 73 controls the measurement matrix buffer 75 to generate a product of the measurement matrix Φ and the vector u according to the 6 multipath channels, and then outputs the product to the multipath interference canceller 71.

In step 801 of the second iteration, the multipath interference canceller 71 cancels the interference produced by foregoing 6 multipath channels on the pilot subcarriers. In step 802, the search unit 72 finds remaining 2 multipath channels in the updated pilot subcarriers. Meanwhile, in step 803, the control unit 73 determines that the current number of iterations is the second iteration. Thus, step 807 is then executed. In step 807, the control unit 73 selects a multipath channel among the multipath channels found in the second iteration and updates the vector u in matrix expression (7) accordingly. In step 808, the control unit 73 adds up the 6 multipath channels in the register 74 and the multipath channels found in the second iteration and provides the result to the operation unit 76. In step 809, the operation unit 76 generates a product of the latest vector u and a 2D FFT matrix (for example, the matrix B in the matrix expression (7)) to obtain a current time-frequency domain channel response.

In step 810, the control unit 73 selects a pilot pattern among a plurality of preconfigured pilot patterns (also known to both the transmitter and the receiver) according to the multipath channel number, the pilot number, and/or the spectrum sensing result and transmits a pilot pattern index corresponding to the pilot pattern to the transmitter. The control unit 73 merely updates the selected measurement matrix Φ when the pilot pattern selected by the control unit 73 is updated. The compressive sensing channel parameter estimation method performed regarding an OFDM symbol is completed after step 810.

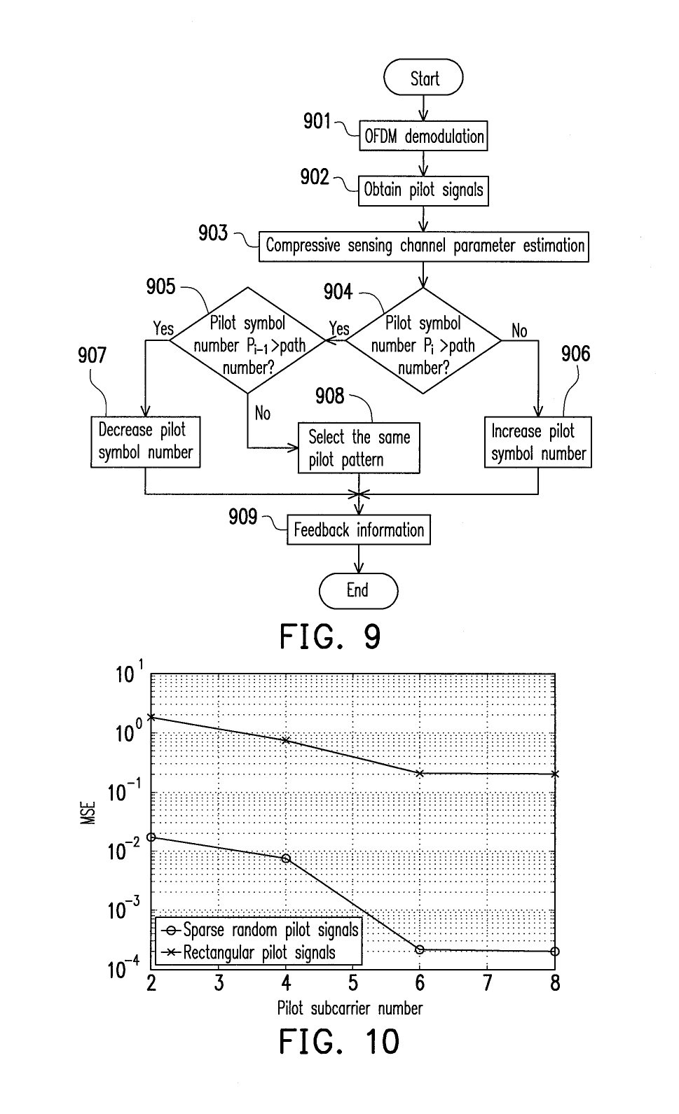

FIG. 9 is a flowchart of an adaptive pilot pattern selection method according to an exemplary embodiment of the disclosure. The adaptive pilot pattern selection method is adapted to a transmitter 50, a receiver 60, and a compressive sensing channel parameter estimator 70.

Herein the adaptive pilot pattern selection method will be described in detail with reference to FIG. 5, FIG. 6, and FIG. 9. In the present exemplary embodiment, it is assumed that the transmitter 50 and the receiver 60 recognize 4 pilot patterns in advance, wherein the 4 pilot patterns respectively have pilot numbers P₀, P₁, P₂, and P₃, as listed in following Table 5. It is noted herein that the 4 pilot patterns are all sparse random pilot patterns such that the receiver 60 could perform channel parameter estimation through compressive sensing.

TABLE 5

| Pilot Pattern Index | Pilot Number |
|---|---|
| P₀(Pₘᵢₙ) | 3 |
| P₁(Pᵢₙᵢ) | 6 |
| P₂ | 9 |
| P₃(Pₘₐₓ) | 12 |

In foregoing Table 5, P₀ is the smallest pilot number Pₘᵢₙ, P₁ may be an initial pilot number Pᵢₙᵢ, and P₃ is the largest pilot number Pₘₐₓ. The receiver 60 demodulates an OFDM symbol in step 901 and obtains pilot signals (subcarriers) in step 902. In step 903, the receiver 60 further executes a compressive sensing channel parameter estimation method. The detailed technical content of step 903 could be referred to FIG. 8. However, the implementation of the present embodiment is not limited to the procedure illustrated in FIG. 8, and the present embodiment may also be implemented by using any other channel parameter estimation method compliant with the compressive sensing theory. The embodiment illustrated in FIG. 8 is merely an exemplary embodiment.

In step 904, after obtaining all the multipath channels, the receiver 60 determines whether the pilot symbol number Pᵢ of the currently used pilot pattern is greater than the number of all multipath channels, where the index i represents that currently the adaptive pilot pattern selection method is executed on the i^{th} OFDM frame. It is noted herein that the pilot symbol number may be the pilot number. If it is determined in step 904 that the pilot symbol number Pᵢ is greater than the number of all multipath channels, step 905 is executed after step 904. Otherwise, step 906 is executed after the step 904.

In the step 905, the receiver 60 further determines whether the pilot symbol number Pᵢ₋₁ of the pilot pattern used for demodulating a previous OFDM symbol (or a previous cycle) is greater than the number of all multipath channels. If it is determined in the step 905 that the pilot symbol number Pᵢ₋₁ is greater than the number of all multipath channels, step 907 is executed after the step 905. Otherwise, step 908 is executed after the step 905.

In the step 906, the receiver 60 increases the pilot symbol number (the upper limit for increasing the pilot symbol number is Pₘₐₓ). In step 907, the receiver 60 decreases the pilot symbol number (the lower limit for decreasing the pilot symbol number is Pₘᵢₙ). In the step 908, the receiver 60 uses the same pilot symbol number. In the step 909, the receiver 60 finds out the pilot pattern index corresponding to the current pilot symbol number and transmits the pilot pattern index (feedback information) back to the transmitter 50. The transmitter 50 uses the pilot pattern corresponding to the pilot pattern index selected by the receiver 60 according to the feedback information to allocate the pilot signals of the next OFDM frame (or next cycle) onto the OFDM subcarriers corresponding to the pilot pattern and then transmits the OFDM subcarriers to the receiver 60.

For example, since the number of preconfigured pilot patterns is fixed, if the receiver 60 originally uses a pilot pattern corresponding to the pilot pattern index P₁, when the receiver 60 decides to increase the pilot symbol number through foregoing steps, it could only increase the pilot symbol number from P₁ to P₂. Similarly, if the receiver 60 originally uses a pilot pattern corresponding to the pilot pattern index P₂, when the receiver 60 decides to decrease the pilot symbol number through foregoing steps, it could only decrease the pilot symbol number from P₂ to P₁. The adaptive pilot pattern selection method executed regarding an OFDM symbol is completed after the step 909.

FIG. 10 illustrates a mean squared error (MSE) simulation result of OFDM channel estimation based on compressive sensing technique. Referring to FIG. 10, the simulation result corresponding to symbol “X” indicates a mean squared error (MSE) of a compressive sensing-based channel parameter estimation method by using rectangular pilot pattern signals. In FIG. 10, the horizontal axis indicates the pilot subcarrier number (i.e., the pilot number), and the vertical axis indicates the MSE. The simulation result corresponding to symbol “∘” indicates a MSE of a compressive sensing-based channel parameter estimation method by using sparse random pilot signals. The simulation parameters are obtained in an ITU VA channel, the ITU VA channel has 6 multipath channels, the pilot signal density AK in the frequency domain is 4, and the total subcarrier number D is 16. It could be understood by referring to the MSE simulation results presented by FIG. 10 that a channel parameter estimation could be successfully performed through the compressive sensing-based channel parameter estimation method by using at least 6 pilot signals and satisfies MSE conditions. However, the compressive sensing-based channel parameter estimation method using the rectangular pilot pattern signals does not provide a satisfactory result.

Even though the simulations illustrated in FIG. 10 is performed in an ITU VA channel, the adaptive pilot pattern selection method and the compressive sensing channel parameter estimation method provided by the disclosure may also be applied to data transmission techniques using underwater acoustic channels.

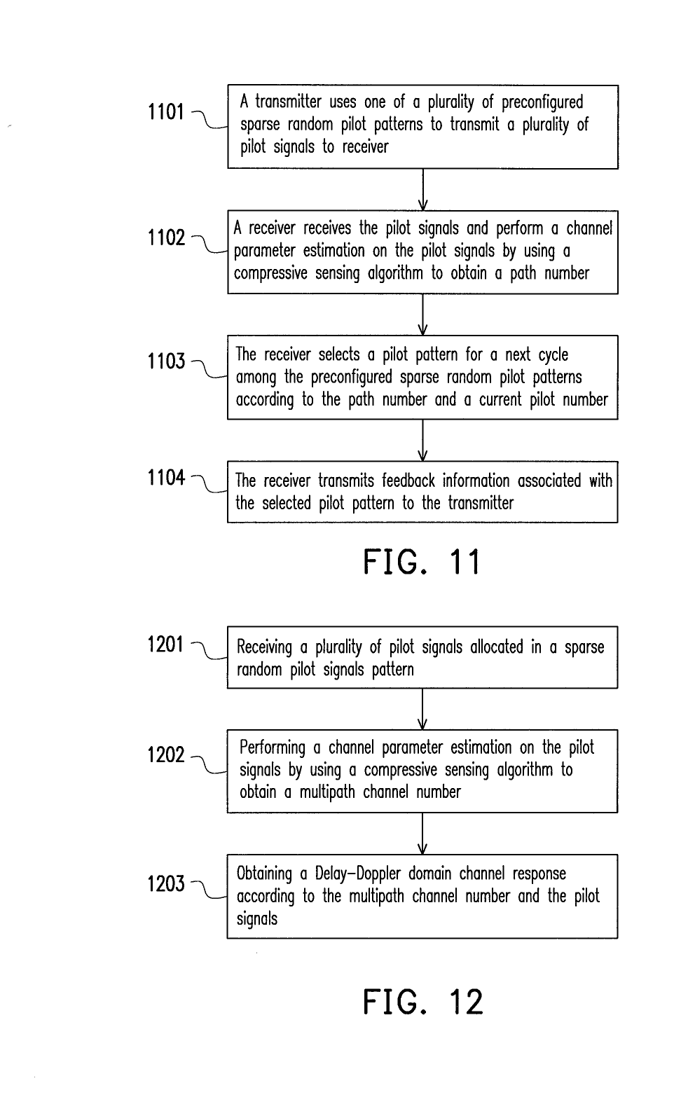

FIG. 11 is a flowchart of a channel parameter estimation method according to an exemplary embodiment of the disclosure. Referring to FIG. 5, FIG. 6, and FIG. 11, the channel parameter estimation method is adapted to a wireless communication system. The wireless communication system includes a transmitter and a receiver. The channel parameter estimation method includes following steps. In step 1101, the transmitter 50 transmits a plurality of pilot signals to the receiver 60 by using one of a plurality of preconfigured sparse random pilot patterns. In step 1102, the receiver 60 receives the pilot signals allocated in the sparse random pilot pattern, and the receiver 60 performs a channel parameter estimation on the pilot signals by using a compressive sensing algorithm to obtain a multipath channel number. In step 1103, the receiver 60 selects a pilot pattern for a next cycle (for example, a next OFDM frame) among the preconfigured sparse random pilot patterns according to the multipath channel number and a current pilot number. In step 1104, the receiver 60 transmits feedback information associated with the selected pilot pattern to the transmitter 50. The implementation of the channel parameter estimation method illustrated in FIG. 11 may further include various steps illustrated in FIG. 8 and FIG. 9. However, these steps will not be described herein.

FIG. 12 is a flowchart of a channel parameter estimation method according to an exemplary embodiment of the disclosure. Referring to FIG. 5, FIG. 6, and FIG. 12, the channel parameter estimation method illustrated in FIG. 12 is adapted to a receiver. The channel parameter estimation method includes following steps. In step 1201, the receiver 60 receives a plurality of pilot signals allocated in a sparse random pilot pattern. In step 1202, the receiver 60 performs a channel parameter estimation on the pilot signals by using a compressive sensing algorithm to obtain a multipath channel number. In step 1203, the receiver 60 obtains a Delay-Doppler domain channel response according to the multipath channel number and the pilot signals. The implementation of the channel parameter estimation method illustrated in FIG. 12 may further include various steps illustrated in FIG. 8. However, these steps will not be described herein.

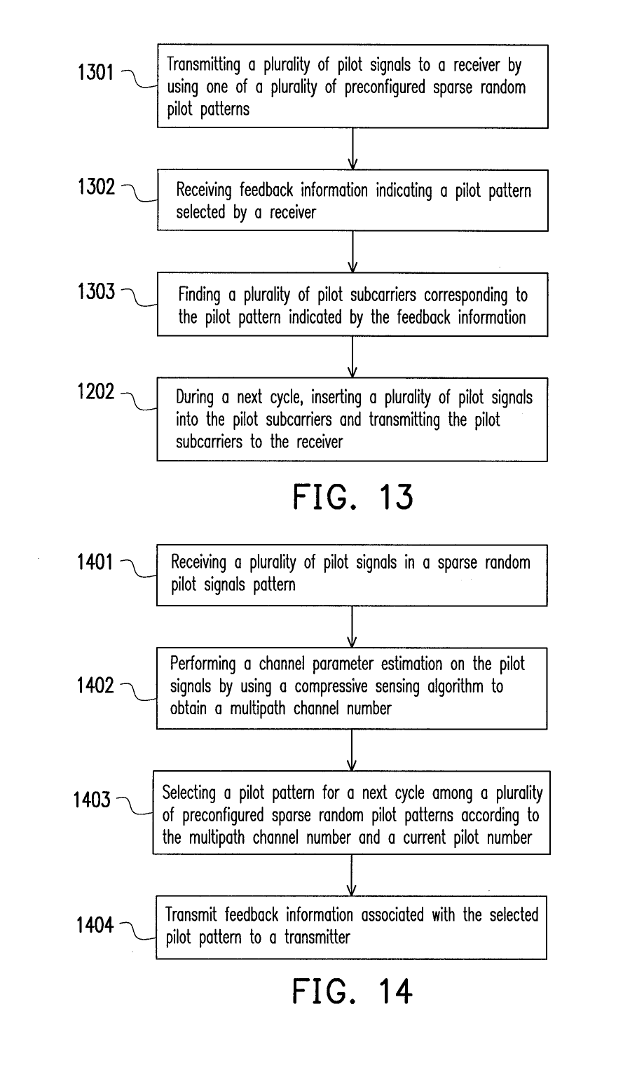

FIG. 13 is a flowchart of a channel parameter estimation method according to an exemplary embodiment of the disclosure. Referring to FIG. 5, FIG. 6, and FIG. 13, the channel parameter estimation method illustrated in FIG. 13 is adapted to a transmitter of a wireless communication system. The channel parameter estimation method includes following steps. In step 1301, the transmitter 50 transmits a plurality of pilot signals to the receiver 60 by using one of a plurality of preconfigured sparse random pilot patterns. It is noted herein that the preconfigured sparse random pilot patterns respectively have different pilot numbers (as shown in foregoing Table 5).

In step 1302, the transmitter 50 receives feedback information indicating a pilot pattern selected by the receiver 60 from the receiver 60. In step 1303, the transmitter 50 finds a plurality of pilot subcarriers corresponding to the pilot pattern indicated by the feedback information. In step 1304, during a next cycle (for example, a next OFDM frame), the transmitter 50 inserts a plurality of pilot signals into the pilot subcarriers and then transmits the pilot subcarriers to the receiver 60. The implementation of the channel parameter estimation method illustrated in FIG. 13 may further include various steps illustrated in FIG. 9. However, these steps will not be described herein.

FIG. 14 is a flowchart of a channel parameter estimation method according to an exemplary embodiment of the disclosure. Referring to FIG. 5, FIG. 6, and FIG. 14, the channel parameter estimation method illustrated in FIG. 14 is adapted to a receiver. The channel parameter estimation method includes following steps. In step 1401, the receiver 60 receives a plurality of pilot signals allocated in a sparse random pilot pattern from the transmitter 50. In step 1402, the receiver 60 performs a channel parameter estimation on the pilot signals by using a compressive sensing algorithm to obtain a multipath channel number. In step 1403, the receiver 60 selects a pilot pattern for a next cycle among a plurality of preconfigured sparse random pilot patterns according to the multipath channel number and a current pilot number. In step 1403, the receiver 60 transmits feedback information associated with the selected pilot pattern to the transmitter 50. The implementation of the channel parameter estimation method illustrated in FIG. 14 may further include various steps illustrated in FIG. 8 and FIG. 9. However, these steps will not be described herein.

In summary, exemplary embodiments of the disclosure provide an adaptive pilot pattern selection method, a compressive sensing-based channel parameter estimation method using sparse random pilot signals, and a wireless communication system, a base station, and a wireless communication device using the same methods. The channel parameter estimation method in the disclosure has following technical features.

Sparse pilot assignment is adopted in the disclosure. In the disclosure, sparse pilot signals are designed according to the characteristic of compressive sensing-based channel parameter estimation method, and the number of pilot subcarriers is determined according to the number of multipath channels to be estimated, so that the number of pilot signals required is greatly reduced and the spectrum efficiency is increased accordingly.

Uniformly at random pilot assignment is adopted in the disclosure. In the disclosure, random pilot signals are designed according to the characteristic of compressive sensing-based channel parameter estimation method so that the possibility of FFT pruning pilot subcarriers is reduced. Even if FFT pruning is encountered during the channel parameter estimation process, the compressive sensing-based channel parameter estimation method could still work normally. Alternatively, another pilot subcarrier could be used for transmitting pilot signals through a back-off procedure.

An adaptive pilot pattern selection method is adopted in the disclosure. In the disclosure, the number of pilot signals could be adaptively determined by performing channel parameter estimation through a compressive sensing technique. When the number of multipath channels in a channel increases, the number of pilot subcarriers is increased, and when the number of multipath channels in a channel decreases, the number of pilot subcarriers is reduced. Thereby, the overall spectrum efficiency and channel estimation performance could be effectively improved.

A multipath interference suppression channel estimator is adopted in the disclosure. In the disclosure, the multipath interference cancelling algorithm for channel parameter estimation is designed according to the characteristic of the compressive sensing-based channel parameter estimation method, where those paths having the highest response values could be estimated firstly, and after interference of these paths is cancelled, the other paths having lower response values could be estimated in subsequent operations. Thereby, the problem of too many multipath channels could be effectively resolved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A channel parameter estimation method, adapted to a communication system, wherein the communication system comprises a transmitter and a receiver, the channel parameter estimation method comprises:
transmitting, at the transmitter, a plurality of pilot signals to the receiver by using one of a plurality of preconfigured sparse random pilot patterns;
receiving, at the receiver, the plurality of pilot signals, performing a channel parameter estimation on the plurality of pilot signals by using a compressive sensing algorithm to obtain a multipath channel number;
selecting, at the receiver, a pilot pattern for a next cycle among the preconfigured sparse random pilot patterns according to the multipath channel number and a current pilot number; and
transmitting, at the receiver, feedback information associated with the selected pilot pattern to the transmitter.

2. The channel parameter estimation method according to claim 1, further comprising:
after receiving the feedback information at the transmitter, using the pilot pattern corresponding to the feedback information at the transmitter during the next cycle.

3. The channel parameter estimation method according to claim 1, further comprising:
after receiving the feedback information at the transmitter, obtaining a plurality of pilot subcarriers corresponding to a pilot pattern indicated by the feedback information at the transmitter, and during the next cycle;
inserting, at the transmitter, a plurality of pilot signals into the pilot subcarriers; and
transmitting, at the transmitter, the pilot subcarriers to the receiver.

4. The channel parameter estimation method according to claim 1, further comprising:
estimating, at the receiver, a plurality of channel parameters based on a compressive sensing algorithm by using the pilot signals.

5. The channel parameter estimation method according to claim 1, further comprising:
estimating, at the receiver, a plurality of channel parameters according to the pilot signals by using a compressive sensing algorithm and a multipath interference cancelling algorithm.

6. The channel parameter estimation method according to claim 5, wherein the step of selecting, at the receiver, a pilot pattern for the next cycle among the preconfigured sparse random pilot patterns according to the multipath channel number and the current pilot number comprises:
comparing, at the receiver, the multipath channel number with the current pilot number and generating a first comparison result;
comparing, at the receiver, the multipath channel number with a pilot number of a previous cycle and generating a second comparison result;
adjusting, at the receiver, the pilot number according to the first comparison result and the second comparison result; and
selecting, at the receiver, a pilot pattern for the next cycle among the preconfigured sparse random pilot patterns according to the pilot number.

7. The channel parameter estimation method according to claim 5, further comprising:
obtaining, at the receiver, a multipath channel and a delay-doppler domain channel response according to the pilot signals.

8. The channel parameter estimation method according to claim 3, further comprising:
when the transmitter detects that one of a plurality of subcarriers currently used by the pilot signals is fast Fourier transform (FFT) pruned, placing a pilot signal at another subcarrier adjacent to the pruned subcarrier through the transmitter.

9. The channel parameter estimation method according to claim 3, further comprising:
when the receiver detects that one of a plurality of subcarriers currently used by the pilot signals is interfered, the receiver receives a pilot signal on another subcarrier adjacent to the interfered subcarrier.

10. The channel parameter estimation method according to claim 5, further comprising:
executing. at the receiver, the multipath interference cancelling algorithm before executing the compressive sensing algorithm.

11. The channel parameter estimation method according to claim 5, wherein the step of estimating, at the receiver, the channel parameters according to the pilot signals by using the compressive sensing algorithm and the multipath interference cancelling algorithm comprises:
executing, at the receiver, the multipath interference cancelling algorithm before executing the compressive sensing algorithm.

12. The channel parameter estimation method according to claim 5, wherein the step of estimating, at the receiver, the channel parameters according to the pilot signals by using the compressive sensing algorithm and the multipath interference cancelling algorithm comprises:
in a first iteration for estimating the channel parameters, obtaining a plurality of multipath channels of the first iteration from the pilot signals at the receiver by using the compressive sensing algorithm without executing the multipath interference cancelling algorithm; and
in a second iteration for estimating the channel parameters, cancelling interference of the multipath channels of the first iteration on the pilot signals at the receiver, by using the multipath interference cancelling algorithm.

13. The channel parameter estimation method according to claim 12, wherein the step of estimating, at the receiver, the channel parameters according to the pilot signals by using the compressive sensing algorithm and the multipath interference cancelling algorithm further comprises:
after cancelling interference of the multipath channels of the first iteration on the pilot signals, obtaining remaining multipath channels from the pilot signals, at the receiver, by using the compressive sensing algorithm.

14. The channel parameter estimation method according to claim 7, wherein after the step of obtaining at the receiver, the delay-doppler domain channel response, the channel parameter estimation method further comprises:
transforming, at the receiver, the delay-doppler domain channel response into a time-frequency domain channel response by using a two-dimensional (2D) Fast Fourier Transform(FFT).

15. A channel parameter estimation method, adapted to a receiver, the channel parameter estimation method comprising:
receiving, at the receiver, a plurality of pilot signals allocated in a sparse random pilot pattern;
performing, at the receiver, a channel parameter estimation on the plurality of pilot signals by using a compressive sensing algorithm to obtain a multipath channel number; and
obtaining, at the receiver, a delay-doppler domain channel response according to the multipath channel number and the plurality of pilot signals.

16. The channel parameter estimation method according to claim 15, wherein the step of performing, at the receiver, the channel parameter estimation on the pilot signals to obtain the multipath channel number comprises:
executing, at the receiver, a multipath interference cancelling algorithm before executing the compressive sensing algorithm.

17. The channel parameter estimation method according to claim 15, wherein the step of performing, at the receiver, the channel parameter estimation on the pilot signals to obtain the multipath channel number comprises:
in a first iteration for estimating a plurality of channel parameters, obtaining a plurality of multipath channels of the first iteration from the pilot signals at the receiver by using the compressive sensing algorithm without executing the multipath interference cancelling algorithm; and
in a second iteration for estimating the channel parameters, cancelling interference of the multipath channels of the first iteration on the pilot signals at the receiver by using the multipath interference cancelling algorithm.

18. The channel parameter estimation method according to claim 17, wherein the step of performing, at the receiver, the channel parameter estimation on the pilot signals by using the compressive sensing algorithm and the multipath interference cancelling algorithm to obtain the multipath channel number comprises:
after cancelling interference of the multipath channels of the first iteration on the pilot signals, obtaining remaining multipath channels from the pilot signals at the receiver by using the compressive sensing algorithm.

19. The channel parameter estimation method according to claim 15, wherein after the step of obtaining, at the receiver, the Delay-Doppler domain channel response, the channel parameter estimation method further comprises:
transforming, at the receiver, the delay-doppler domain channel response into a time-frequency domain channel response through a two-dimensional Fast Fourier Transform (2D FFT).

20. A channel parameter estimation method, adapted to a transmitter, the channel parameter estimation method comprising:
transmitting, at the transmitter, a plurality of pilot signals to a receiver by using one of a plurality of preconfigured sparse random pilot patterns;
receiving, at the transmitter, feedback information associated with a pilot pattern selected by the receiver from the receiver; and
obtaining a plurality of pilot subcarriers corresponding to a pilot pattern indicated by the feedback information at the transmitter, during a next cycle, inserting a plurality of pilot signals into the pilot subcarriers at the transmitter, and transmitting the pilot subcarriers to the receiver at the transmitter.

21. The channel parameter estimation method according to claim 20 comprising:
when the transmitter detects that one of a plurality of subcarriers currently used by the pilot signals is Fast Fourier Transform (FFT) pruned, the transmitter allocates a plurality of pilot signals at another subcarrier adjacent to the pruned subcarrier.

22. The channel parameter estimation method according to claim 20, wherein
the preconfigured sparse random pilot patterns respectively have different pilot numbers.

23. A channel parameter estimation method, adapted to a receiver, the channel parameter estimation method comprising:
receiving, at the receiver, a plurality of pilot signals in a sparse random pilot pattern from a transmitter;
performing, at the receiver, a channel parameter estimation on the pilot signals by using a compressive sensing algorithm to obtain a multipath channel number;
selecting, at the receiver, a pilot pattern for a next cycle among a plurality of preconfigured sparse random pilot patterns according to the multipath channel number and a current pilot number; and
transmitting, at the receiver, feedback information associated with the selected pilot pattern to the transmitter.

24. The channel parameter estimation method according to claim 23, further comprising:
obtaining, at the receiver, a delay-doppler domain channel response according to the multipath channel number and the pilot signals.

25. The channel parameter estimation method according to claim 23, wherein the step of performing, at the receiver, the channel parameter estimation on the pilot signals to obtain the multipath channel number comprises:
comparing, at the receiver, the multipath channel number with the current pilot number and generating a first comparison result;
comparing, at the receiver, the multipath channel number with a pilot number of a previous cycle and generating a second comparison result;
adjusting, at the receiver, the pilot number according to the first comparison result and the second comparison result; and
selecting, at the receiver, a pilot pattern for the next cycle among the preconfigured sparse random pilot patterns according to the pilot number.

26. The channel parameter estimation method according to claim 23 comprising:
when the receiver determines that one of a plurality of subcarriers currently used by the pilot signals is interfered, the receiver receives a pilot signal on another subcarrier adjacent to the interfered subcarrier.

27. The channel parameter estimation method according to claim 23, wherein the step of estimating, at the receiver, a plurality of channel parameters according to the pilot signals comprises:
executing, at the receiver, a multipath interference cancelling algorithm before executing the compressive sensing algorithm.

28. The channel parameter estimation method according to claim 27, wherein the step of estimating, at the receiver, the channel parameters according to the pilot signals further comprises:
in a first iteration for estimating the channel parameters, obtaining a plurality of multipath channels of the first iteration from the pilot signals at the receiver by using the compressive sensing algorithm without executing the multipath interference cancelling algorithm; and
in a second iteration for estimating the channel parameters, cancelling interference of the multipath channels of the first iteration on the pilot signals at the receiver by using the multipath interference cancelling algorithm.

29. The channel parameter estimation method according to claim 28, wherein the step of estimating, at the receiver, the channel parameters according to the pilot signals further comprises:
after canceling interference of the multipath channels of the first iteration on the pilot signals at the receiver, obtaining, at the receiver, remaining multipath channels from the pilot signals by using the compressive sensing algorithm.

30. The channel parameter estimation method according to claim 24, wherein after the step of obtaining, at the receiver, the delay-doppler domain channel response, the channel parameter estimation method further comprises:
transforming, at the receiver, the delay-doppler domain channel response into a time-frequency domain channel response through a two-dimensional (2D) Fast Fourier Transform (2D FFT).

31. The channel parameter estimation method according to claim 23, wherein the preconfigured sparse random pilot patterns respectively have different pilot numbers.
